(19) United States
(12) Patent Application Publication
(10) Pub. No.: US 2020/0413291 A1
(43) Pub. Date: Dec. 31, 2020

(54) Multi-Band Sharing In A Wireless Communication System

(71) Applicant: NXP USA, Inc., Austin, TX (US)

(72) Inventors: Liwen Chu, Austin, TX (US); Hongyuan Zhang, Austin, TX (US); Huiling Lou, Austin, TX (US); Rui Cao, Austin, TX (US); Yan Zhang, Austin, TX (US)

(21) Appl. No.: 16/911,102

(22) Filed: Jun. 24, 2020

Related U.S. Application Data
(60) Provisional application No. 62/866,480, filed on Jun. 25, 2019.
(60) Provisional application No. 62/870,455, filed on Jul. 3, 2019.

(51) Int. Cl. H04W 28/06; H04W 88/06; H04W 80/02; H04L 29/08; H04L 5/00; H04W 8/00; H04W 8/22; H04W 76/15

(52) U.S. Cl. CPC H04W 28/06; H04W 88/06; H04W 80/02; H04W 76/15; H04L 5/0053; H04W 8/005; H04W 8/22; H04L 69/324

(57) ABSTRACT

A method for multi-band sharing in a wireless communication system includes transmitting a capability announcement of a link-pair of Multi-Link Device (MLD), wherein the link-pair comprises a first link and a second link. The first link of the MLD transceives using a first transceiver mode based on the capability announcement. The second link of the MLD transceives using a second transceiver mode based on the capability announcement.

### CROSS-REFERENCE TO RELATED APPLICATIONS

This application is a utility application claiming priority to co-pending U.S. Provisional Application Ser. No. 62/866,480 filed on Jun. 25, 2019, entitled “MULTI-BAND OPERATION: BAND SHARING METHODS,” and co-pending U.S. Provisional Application Ser. No. 62/870,455 filed on Jul. 3, 2019, entitled “MULTI-BAND OPERATION: BAND SHARING METHODS,” the entireties of which are incorporated by reference herein.

### FIELD

This disclosure relates generally to wireless communication systems, and more specifically to sharing frequency bands between a pair of communication links of one or more Multi-Link Devices (MLD).

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a schematic view of a multi-band wireless communication system, in accordance with an example embodiment of the present disclosure.

FIG. 2 is a graphical view of a transmission from an Access Point (AP) MLD, in accordance with the example embodiment of FIG. 1.

FIG. 3 is a graphical view of a transmission to an AP MLD, in accordance with the example embodiment of FIG. 1.

FIG. 4 is a graphical view of an asynchronous transmission between a first link and a second link of an MLD in accordance with the example embodiment of FIG. 1.

FIG. 5 is a flowchart representation of a method for multi-band sharing in a wireless communication system, in accordance with an example embodiment of the present disclosure.

FIG. 6 is a flowchart representation of a method for multi-band sharing in a wireless communication system, in accordance with an example embodiment of the present disclosure.

### DETAILED DESCRIPTION

Embodiments described herein provide for the sharing of frequency bands over a pair of communication links of one or more MLD devices in a wireless communication system. Example embodiments of an MLD device include an AP MLD device or a STA MLD device, each having a plurality of APs or STAs respectively. Each AP or STA are capable of transceiving (e.g., transmitting and/or receiving), in one of a plurality of links or channels. Each channel operates in one of a plurality of frequency bands having a center frequency. In some example embodiments, the center frequency is a fundamental frequency. In another example embodiment, the center frequency is a mean frequency (e.g., the average frequency of a 2.4 GHz band spanning 2,400 Hz to 2,483.5 Hz).

In one example embodiment, including one or more APs of one AP MLD and one or more STAs of one STA MLD, the establishment of a communication channel is formed between the one or more AP links of the AP MLD and a corresponding one or more STA links of the STA MLD. The AP MLD broadcasts a link sharing capability between any two pair of AP links (e.g., AP1 16 and AP2 18). In another embodiment, the AP MLD transmits the link sharing capability of any two pairs of its AP links to the STA MLD during association. Similarly, the STA MLD transmits the link sharing capability of any two pairs of its STA links to the AP MLD during association. In one example, a pair of links (of the AP MLD and/or STA MLD) has a capability of simultaneous transmission or reception, in either in synchronous or asynchronous mode. In another example, a pair of links is capable of asynchronously transmitting on one link, while asynchronously receiving on the other link.

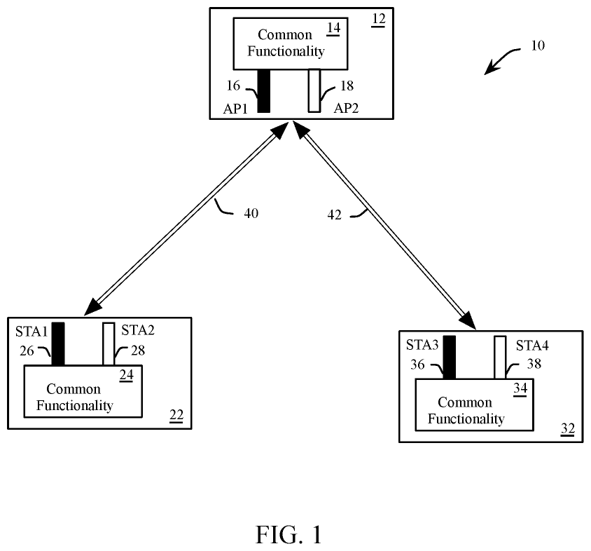

FIG. 1 shows an example embodiment 10 of a multi-band wireless communication system. The embodiment 10 includes an AP MLD 12 having a common MAC up layer functionality 14 providing common 802.11 functions for an associated first AP (AP1) 16 and a second AP (AP2) 18. The embodiment 10 further includes a STA MLD 22 having a common MAC up layer functionality 24 for an associated first STA (STA1) 26 and a second STA (STA2) 28. The embodiment 10 further includes a STA MLD 32 having a common MAC up layer functionality 34 for an associated third STA (STA3) 36 and a fourth STA (STA4) 38. The AP MLD 12 transceives with the STA MLD 22 over a communication channel 40. In one example embodiment, the communication channel 40 establishes a communication between AP1 16 and STA1 26, and between AP2 18 and STA2 28. Similarly, the AP MLD 12 transceives with the STA MLD 32 over a communication channel 42, which establishes a communication between AP1 16 and STA3 36, and between AP2 18 and STA4 38.

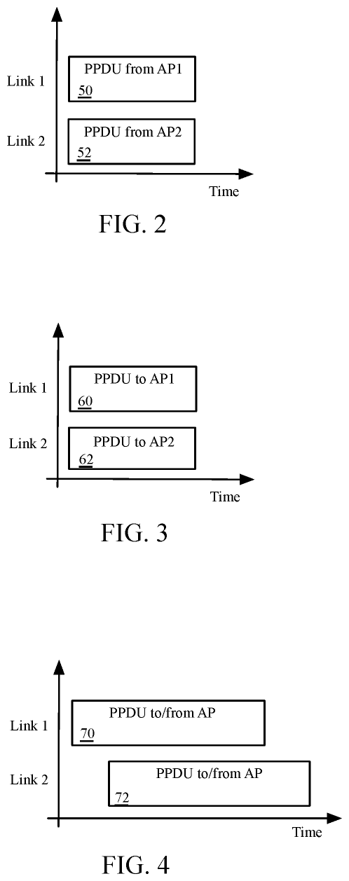

FIG. 2 with ongoing reference to FIG. 1 shows an example embodiment of a transmission from the AP MLD 12 to a STA MLD (22 or 32). In one example embodiment, the AP MLD 12 first broadcasts a respective capability announcement for the link-pair AP1 16 and AP2 18. Each respective capability announcement indicates support for a synchronous mode capability between AP1 16 and AP2 18. The AP MLD 12 transmits a Physical Layer Convergence Procedure Protocol Data Unit (PPDU) 50 from AP1 16 to one of the links of STA MLD 22 or STA MLD 32. Each PPDU transceived at the physical layer of the Open Systems Interconnection (OSI) network is derived from an Aggregated Medium Access Control (MAC) Protocol Data Unit (A-MPDU) from a MAC layer of the OSI network. The AP MLD 12 also synchronously transmits a PPDU 52 from AP2 18 to one of the links of STA MLD 22 or STA MLD 32, where the end time of PPDU 50 temporally aligns with the end time of PPDU 52.

FIG. 3 with ongoing reference to FIG. 1 shows an example embodiment of a transmission from a STA MLD (22 or 32) to the AP1 16 and AP2 18 of AP MLD 12. In one example embodiment, the MLD 12 first broadcasts a respective capability announcement for the link-pair AP1 16 and AP2 18, received by STA MLD (22 or 32). Each respective capability announcement indicates support for a synchronous mode capability between AP1 16 and AP2 18. The STA MLD (22 or 32) transmits a PPDU 60 to AP1 16 and also synchronously transmits a PPDU 62 to AP2 18, where the end time of PPDU 60 temporally aligns with the end time of PPDU 62.

FIG. 4 with ongoing reference to FIG. 1 shows an example embodiment of an asynchronous transmission between AP MLD 12 and STA MLD 22 (or similarly STA MLD 32). In one example embodiment, a PPDU 70 is transmitted from AP1 16 to STA1 26, while a PPDU 72 is asynchronously transmitted from AP2 18 to STA2 28, wherein PPDU 70 and PPDU 72 have different respective start and end times. In another example embodiment, the PPDU 70 is transmitted from STA1 26 to AP1 16, while a PPDU 72 is asynchronously transmitted from STA2 28 to AP2 18, wherein PPDU 70 and PPDU 72 have different respective start and end times. In another example embodiment, the PPDU 70 is transmitted from STA1 26 to AP1 16, while a PPDU 72 is asynchronously transmitted from AP2 18 to STA2 28, wherein PPDU 70 and PPDU 72 have different respective start and end times.

Other embodiments of multi-band sharing in a wireless communication system include coordinating transceiver capabilities between any two pairs of AP or STA links by transmitting a capability announcement from each respective link-pair. When a pair of links each have an asynchronous mode capability, the first and second links need not start nor finish at the same time. In one embodiment, the two links each transmit a PPDU with a same mode therebetween. In another embodiment, the two links each receive a PPDU with a same mode therebetween. In another embodiment, one of two links transmits a PPDU, while the other link receives a PPDU with a same mode therebetween.

In another example embodiment, an AP MLD, or a STA MLD announce a frequency distance threshold between a pair of links based on a frequency distance between a center frequency of one link to a center frequency of another link. In one embodiment, when a frequency difference between the two links exceeds the frequency distance threshold, the two links will transceive (e.g., transmit, receive or both transmit and receive) with an asynchronous mode capability. In another embodiment, when a frequency difference between the two links is less than, or equal to, the frequency distance threshold, the two links will transceive (e.g., transmit, receive or both transmit and receive) with a synchronous mode capability.

Following a change to a communication channel (e.g., from channel 40 between AP1 16 and STA1 26 to channel 42 between AP1 16 and STA3 36), when a previously broadcast capability announcement over the previous channel 40 includes the frequency distance threshold, the new capability announcement will change based on the new frequency distance between the respective links of the new channel 42. It should be understood that a similar change to a respective capability announcement due to the change to the communication channel also occurs due to a change to a frequency band. In another example embodiment, wherein a communication channel (or frequency band) is changed after broadcasting a capability announcement, without a frequency distance threshold, the AP MLD and/or STA MLD assumes a synchronous mode capability until a new capability announcement is broadcast for the new link-pair used by the new communication channel. In another example embodiment, wherein a communication channel (or frequency band) is changed after broadcasting a capability announcement, without a frequency distance threshold, the AP MLD and/or STA MLD assumes the same transceiver mode if a frequency difference between the center frequencies of the new link-pair has increased until a new capability announcement is broadcast for the new link-pair used by the new communication channel.

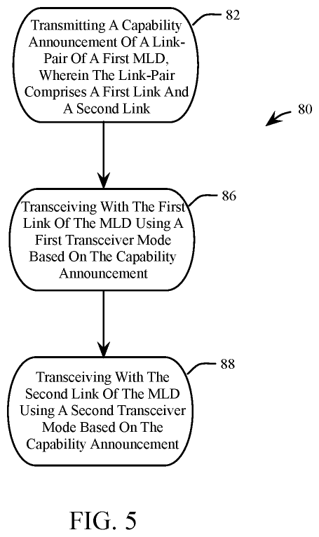

FIG. 5, with reference to FIG. 1, shows an example embodiment 80 of a method for multi-band sharing in a wireless communication system 10. At 82 a first capability announcement is broadcast from a first link of a first MLD (e.g., AP1 16 of AP MLD 12). At 84, a second capability announcement is broadcast from a second link of a second MLD (e.g., STA1 26 of STA MLD 22). At 86, the first link of the first MLD (e.g., AP1 16), transceives using a transceiver mode based on the first capability announcement. At 88, the second link of the second MLD (e.g., STA1 26), transceives using the transceiver mode.

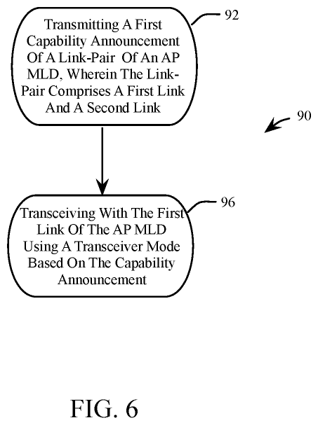

FIG. 6, with reference to FIG. 1, shows an example embodiment 90 of a method for multi-band sharing in a wireless communication system 10. At 92, a first capability announcement is broadcast from a first link of an AP MLD (e.g., AP1 16 of AP MLD 12). At 94, a second capability announcement is broadcast from a second link of a STA MLD (e.g., STA1 26 of STA MLD 22). At 96, the first link of the AP MLD (e.g., AP1 16), transceives using a transceiver mode based on the first capability announcement.

As will be appreciated, embodiments as disclosed include at least the following. In one embodiment, a method for multi-band sharing in a wireless communication system comprises transmitting a capability announcement of a link-pair of a Multi-Link Device (MLD), wherein the link-pair comprises a first link and a second link. The first link of the MLD is transceived using a first transceiver mode based on the capability announcement. The second link of the MLD is transceived using a second transceiver mode based on the capability announcement.

Alternative embodiments of the method for multi-band sharing in a wireless communication system include one of the following features, or any combination thereof. The first transceiver mode and the second transceiver mode are a respective one of an asynchronous mode capability and a synchronous mode capability. The capability announcement comprises a frequency distance threshold equal to an absolute value of a frequency difference between a first center frequency of the first link and a second center frequency of the second link. The first transceiver mode and the second transceiver mode each comprise an asynchronous mode capability when an absolute frequency difference between the first center frequency and the second center frequency is greater than the frequency distance threshold. The first transceiver mode and the second transceiver mode each have a synchronous mode capability when an absolute frequency difference between the first center frequency and the second center frequency is less than or equal to the frequency distance threshold. A frequency band of the second link is changed from a second frequency band comprising the second center frequency, to a third frequency band comprising a third center frequency, wherein the first transceiver mode and the second transceiver mode each comprise an asynchronous mode capability when an absolute frequency difference between the first center frequency and the third center frequency is greater than the frequency distance threshold. The capability announcement does not comprise a frequency distance threshold defining an absolute frequency difference between a first center frequency of the first link and a second center frequency of the second link, and the link-pair transceive with a synchronous mode capability in response to a reduction of a frequency distance between the first center frequency and the second center frequency. The capability announcement does not comprise a frequency distance threshold defining an absolute frequency difference between a first center frequency of the first link and a second center frequency of the second link, and the capability announcement does not change in response to an increase of a frequency distance between the first center frequency and the second center frequency. The MLD is an Access Point (AP) MLD, the capability announcement includes only a synchronous mode capability, the MLD transmits a plurality of Physical Layer Convergence Procedure Protocol Data Units (PPDUs) over the first link and the second link, and the transmission of each of the plurality of PPDUs terminates at a same time. The MLD is an Access Point (AP) MLD, the capability announcement includes only a synchronous mode capability, the MLD receives a plurality of Physical Layer Convergence Procedure Protocol Data Units (PPDUs) over the first link and the second link, and the reception of each of the plurality of PPDUs terminates at a same time.

In another embodiment, an apparatus comprises a first link of a Multi-Link Device (MLD), wherein the first MLD is configured to transmit a capability announcement and to transceiver with the first link using a first transceiver mode based on the capability announcement. The apparatus comprises a second link of the MLD, wherein the second link is configured to transceiver using a second transceiver mode based on the capability announcement.

Alternative embodiments of the apparatus include one of the following features, or any combination thereof. The first transceiver mode and the second transceiver mode are a respective one of an asynchronous mode capability and a synchronous mode capability. The capability announcement comprises at least one of a frequency distance threshold equal to an absolute value of a frequency difference between a first center frequency of the first link and a second center frequency of the second link. The first transceiver mode and the second transceiver mode each comprise an asynchronous mode capability when an absolute frequency difference between the first center frequency and the second center frequency is greater than the frequency distance threshold. The first transceiver mode and the second transceiver mode each have a synchronous mode capability when an absolute frequency difference between the first center frequency and the second center frequency is less than or equal to the frequency distance threshold. A frequency band of the second link is changed from a second frequency band comprising the second center frequency, to a third frequency band comprising a third center frequency, wherein the first transceiver mode and the second transceiver mode each have an asynchronous mode capability when an absolute frequency difference between the first center frequency and the third center frequency is greater than the frequency distance threshold.

In another embodiment, a method for multi-band sharing in a wireless communication system comprises transmitting a first capability announcement of a link-pair of an Access Point (AP) Multi-Link Device (MLD), wherein the link-pair comprises a first link and a second link. The first link of the AP MLD transceives using a transceiver mode based on the capability announcement.

Alternative embodiments of the method for multi-band sharing in a wireless communication system include one of the following features, or any combination thereof. The capability announcement comprises a frequency distance threshold equal to an absolute value of a frequency difference between a first center frequency of the first link and a second center frequency of the second link. The transceiver mode comprises an asynchronous mode capability when an absolute frequency difference between the first center frequency and the second center frequency is greater than the frequency distance threshold. The transceiver mode comprises a synchronous mode capability when an absolute frequency difference between the first center frequency and the second center frequency is less than or equal to the frequency distance threshold.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for multi-band sharing in a wireless communication system comprising:
transmitting a capability announcement of a link-pair of a Multi-Link Device (MLD), wherein the link-pair comprises a first link and a second link;
transceiving with the first link of the MLD using a first transceiver mode based on the capability announcement; and
transceiving with the second link of the MLD using a second transceiver mode based on the capability announcement.

2. The method of claim 1 wherein the first transceiver mode and the second transceiver mode are a respective one of an asynchronous mode capability and a synchronous mode capability.

3. The method of claim 1 wherein the capability announcement comprises a frequency distance threshold equal to an absolute value of a frequency difference between a first center frequency of the first link and a second center frequency of the second link.

4. The method of claim 3 wherein the first transceiver mode and the second transceiver mode each comprise an asynchronous mode capability when an absolute frequency difference between the first center frequency and the second center frequency is greater than the frequency distance threshold.

5. The method of claim 3 wherein the first transceiver mode and the second transceiver mode each have a synchronous mode capability when an absolute frequency difference between the first center frequency and the second center frequency is less than or equal to the frequency distance threshold.

6. The method of claim 3 wherein a frequency band of the second link is changed from a second frequency band comprising the second center frequency, to a third frequency band comprising a third center frequency, wherein the first transceiver mode and the second transceiver mode each comprise an asynchronous mode capability when an absolute frequency difference between the first center frequency and the third center frequency is greater than the frequency distance threshold.

7. The method of claim 1 wherein the capability announcement does not comprise a frequency distance threshold defining an absolute frequency difference between a first center frequency of the first link and a second center frequency of the second link, and the link-pair transceive with a synchronous mode capability in response to a reduction of a frequency distance between the first center frequency and the second center frequency.

8. The method of claim 1 wherein the capability announcement does not comprise a frequency distance threshold defining an absolute frequency difference between a first center frequency of the first link and a second center frequency of the second link, and the capability announcement does not change in response to an increase of a frequency distance between the first center frequency and the second center frequency.

9. The method of claim 1 wherein the MLD is an Access Point (AP) MLD, the capability announcement includes only a synchronous mode capability, the MLD transmits a plurality of Physical Layer Convergence Procedure Protocol Data Units (PPDUs) over the first link and the second link, and the transmission of each of the plurality of PPDUs terminates at a same time.

10. The method of claim 1 wherein the MLD is an Access Point (AP) MLD, the capability announcement includes only a synchronous mode capability, the MLD receives a plurality of Physical Layer Convergence Procedure Protocol Data Units (PPDUs) over the first link and the second link, and the reception of each of the plurality of PPDUs terminates at a same time.

11. An apparatus comprising:
a first link of a Multi-Link Device (MLD), wherein the first MLD is configured to transmit a capability announcement and to transceive with the first link using a first transceiver mode based on the capability announcement; and
a second link of the MLD, wherein the second link is configured to transceiver using a second transceiver mode based on the capability announcement.

12. The apparatus of claim 11 wherein the first transceiver mode and the second transceiver mode are a respective one of an asynchronous mode capability and a synchronous mode capability.

13. The apparatus of claim 11 wherein the capability announcement comprises at least one of a frequency distance threshold equal to an absolute value of a frequency difference between a first center frequency of the first link and a second center frequency of the second link.

14. The apparatus of claim 13 wherein the first transceiver mode and the second transceiver mode each comprise an asynchronous mode capability when an absolute frequency difference between the first center frequency and the second center frequency is greater than the frequency distance threshold.

15. The apparatus of claim 13 wherein the first transceiver mode and the second transceiver mode each have a synchronous mode capability when an absolute frequency difference between the first center frequency and the second center frequency is less than or equal to the frequency distance threshold.

16. The apparatus of claim 13 wherein a frequency band of the second link is changed from a second frequency band comprising the second center frequency, to a third frequency band comprising a third center frequency, wherein the first transceiver mode and the second transceiver mode each have an asynchronous mode capability when an absolute frequency difference between the first center frequency and the third center frequency is greater than the frequency distance threshold.

17. A method for multi-band sharing in a wireless communication system comprising:
transmitting a first capability announcement of a link-pair of an Access Point (AP) Multi-Link Device (MLD), wherein the link-pair comprises a first link and a second link; and
transceiving with the first link of the AP MLD using a transceiver mode based on the capability announcement.

18. The method of claim 17 wherein the capability announcement comprises a frequency distance threshold equal to an absolute value of a frequency difference between a first center frequency of the first link and a second center frequency of the second link.

19. The method of claim 18 wherein the transceiver mode comprises an asynchronous mode capability when an absolute frequency difference between the first center frequency and the second center frequency is greater than the frequency distance threshold.

20. The method of claim 18 wherein the transceiver mode comprises a synchronous mode capability when an absolute frequency difference between the first center frequency and the second center frequency is less than or equal to the frequency distance threshold.
